(19) United States
(12) Patent Application Publication
(10) Pub. No.: US 2010/0330337 A1
(43) Pub. Date: Dec. 30, 2010

(54) Crop Residue Baler Integrated With Harvester, Method for Baling Crop Residue, and Resulting Trapezoidal Crop Residue Bale

(76) Inventor: Ben N. Dillon, Delaware, OH (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 12/707,981

(22) Filed: Feb. 18, 2010

Related U.S. Application Data
(63) Continuation-in-part of application No. 12/550,451, filed on Aug. 31, 2009.
(60) Provisional application No. 61/219,806, filed on Jun. 24, 2009.

(51) Int. Cl. A01D 41/12; A01F 12/46; B30B 9/30; B30B 15/30; B65B 13/02; A01D 41/00; A01D 59/00; A01D 41/10; B32B 3/00

(52) U.S. Cl. 428/156; 460/114; 100/8; 100/73; 100/2; 56/14.6

(57) ABSTRACT

One embodiment is a combine having an operator's cab, an engine, a grain harvesting assembly, a grain transfer assembly, a grain bin for receiving grain from the forward section grain transfer assembly, and a transverse crop residue baler disposed at the rear of said combine and moving integrally with said combine. The transverse crop residue baler also can be towed by the combine and is connected to the combine by two widely spaced-apart joints that permit only movement in the pitch axis. The combine can be devoid of an on-board grain bin and comprise a forward unit; the transverse crop residue baler disposed at the rear of and carried by the forward unit; and the combine includes a rearward unit jointedly attached to the forward unit and having, steerable and powered wheel assembly, an on-board grain bin, and a grain off-loading assembly.

### CROSS-REFERENCE TO RELATED APPLICATIONS

This application is a continuation-in-part of application Ser. No. 12/550,451, filed on Aug. 31, 2009; and claims benefit of provisional application Ser. No. 61/219,806, filed on Jun. 24, 2009, the disclosures of which are expressly incorporated herein by reference.

### STATEMENT REGARDING FEDERALLY SPONSORED RESEARCH

Not applicable.

### BACKGROUND

The present disclosure generally relates to grain harvesters (or combines) and farm tractors and more particularly to integrating a crop residue baler with these farm vehicles.

The growth and development of renewable bio fuels and associated processes has created interest and demand for new methods to collect biomass. One area of particular interest is the residue normally left in the field after harvesting grain crops, such as corn, for example. Collecting, storing, transporting, and preserving crop residue presents major problems. It usually is only available in the field once per year. It is not energy concentrated like the grain. It can rot or start to ferment if left unprotected in the weather. It also is almost impossible to transport, as it is currently ejected from a harvester, such as a combine, because it is of very low density.

Secondary processes or machines, such as cob collectors or balers towed by tractors, have been used to increase the density of crop residue and improve its transportability. In some cases, the cob collectors or balers have been towed behind the combine by a pivoting connection. This presents challenges to productivity and maneuverability.

Baling functions for the primary crop have been integrated into cotton pickers. They do not deal with crop residue, which is left in the field with these machines.

The ideal solution to increase crop residue density, transportability, and ability to tolerate weather, is to bale it in a unique shape as an integral part of the harvester with no other machines or processes needed. This requires the baling function of feeding, compressing, forming, and constraining the material to be integrated into the residue handling function of the harvester without interfering with its ability to harvest and transport the desired grain. This is difficult in the typical combine that is commercially available today, due to lack of space inside and on top, since the grain tank takes most of the space on top. They also are subject to weight limitations on both the main and steering axles. A baler can be combined with a conventional combine in a unique embodiment disclosed herein.

These constraints are not present in the articulated harvester disclosed in U.S. Pat. No. 6,012,272. The engine, cooling system, and machinery drives are mounted behind the operator's cab in space normally occupied by the clean grain tank. This arrangement provides space on top of the rear of the machine to mount baling components and insert the baling process into the residue stream. The steering axle weight limitation is not present, since all axles on an articulated machine are load bearing and there is no steering axle.

### BRIEF SUMMARY

One embodiment is a combine having an operator's cab, an engine, a grain harvesting assembly, a grain transfer assembly, a grain bin for receiving grain from said grain transfer assembly, and a transverse crop residue baler disposed at the rear of said combine and moving integrally therewith.

In another embodiment the transverse crop residue baler is towed by a combine, a tractor, or other suitable vehicle, and is connected to the combine by a joint assembly that permits only movement in the pitch axis. When the towing vehicle is a combine, the towed transverse crop baler is connected to the combine by two widely spaced-apart joints that permit only movement in the pitch axis. When the tractor is fitted with, for example, a category 3 or 4 tractor quick hitch, spacing of the two joints is regulated by the hitch category. Of importance for present purposes is that the towed baler/combine or tractor hitch connection is permitted to move only in the pitch axis.

In a further embodiment the combine is devoid of an on-board grain bin and is, thus, a forward unit; the transverse crop residue baler is disposed at the rear of and is carried by the forward unit; and the combine further includes a rearward unit jointedly attached to the forward unit and having, steerable and powered wheel assembly, an on-board grain bin for receiving grain from the forward section grain transfer assembly, and a grain off-loading assembly.

Thus, the transverse crop residue baler can be carried by the forward unit or towed behind the combine or tractor, where the baler is attached to the towing vehicle by connections that permit only baler movement in the pitch (Z-axis or up-and-down movement) axis. Thus, for present purposes, “integral” or “integrally”, as applied to the transverse crop residue baler, means that the baler and combine (or forward towing unit) move together as a single vehicle unit.

The transverse crop residue baler in both embodiments can produce a tied, trapezoidally-configured crop residue bale having a top surface having a width; a bottom surface having a width that is less than the top surface width; a pair of side surfaces sloping inwardly from the top surface to the bottom surface; a front surface; a back surface; and a channel interrupting the bottom surface and running from the front surface to the back surface.

For present purposes, “combine” and “harvester” are used interchangeably.

### BRIEF DESCRIPTION OF THE DRAWINGS

For a fuller understanding of the nature and advantages of the present apparatus and method, reference should be had to the following detailed description taken in connection with the accompanying drawings, in which:

FIG. 1 is an overhead view of an articulated harvester fitted with the integral transverse crop residue baler assembly disclosed herein;

FIG. 2 is a right side elevational view of the articulated harvester of FIG. 1;

FIG. 3 is a left side elevational view of the articulated harvester of FIG. 1;

FIG. 4 is a sectional view taken along line 4-4 of FIG. 1;

FIG. 5 is a sectional view taken along line 5-5 of FIG. 4;

FIG. 6 is a sectional view taken along line 6-6 of FIG. 4;

FIG. 7 is a side view of the disclosed crop reside bale having a unique trapezoidal configuration and lower tunnel;

FIG. 8 is a right side elevational view of an alternative embodiment where the transverse crop residue baler is towed behind a conventional harvester;

FIG. 9 is a top sectional view of the towed crop residue baler of FIG. 8;

FIG. 10 is a sectional view taken along line 10-10 of FIG. 9;

FIG. 11 is an overhead view of the towed crop residue baler of FIGS. 8 and 9 showing only the base structure;

FIG. 12 is a top view of an alternative embodiment of the towed behind crop residue baler of FIGS. 8 and 9 where crop residue windrows, formed by a head equipped with residue choppers and a windrowing hood, can be picked up by the towed crop residue baler in addition, or in the alternative, to crop residue from the forward harvester;

FIG. 13 shows the pickup mechanism for feeding windrowed material lying on the ground into the baler simultaneously with crop residue that is being ejected from the combine after being separated from the grain;

FIG. 14 shows a towed crop baler for crop windrows like that illustrated in FIG. 13, but being towed by a farm tractor, where a modified tow bar and joint assembly are provided by virtue of the use of a tractor for towing;

FIG. 15 is a top view of the tractor towing version of FIG. 14; and

FIG. 16 is a sectional view taken along line 16-16 of FIG. 15.

These drawings will be described in further detail below in connection with the detailed description of the disclosed combine and transverse crop residue baler disclosed herein.

### DETAILED DESCRIPTION

The subject of an articulated harvester, some of which are based on current commercial grain harvester designs, is disclosed in U.S. Pat. Nos. 4,317,326, 4,428,182, 6,012,272, 6,125,618, 6,339,917, 6,604,351, 6,606,844, 6,604,995, 6,604,350, 6,484,485, 6,612,101, 6,233,911, 6,240,711, and 6,167,982. A harvester/grain cart combination can be converted to an “articulated” combine as disclosed in U.S. Pat. No. 6,910,845. Various grain handling and grain unloading techniques are disclosed in U.S. Pat. Nos. 7,143,863 and 7,198,449.

A departure from the art is disclosed in U.S. Pat. No. 6,012,272, however, in that the forward bogey is devoid of an on-board grain bin, but carries the operator's cab, engine, grain harvesting assembly, and grain transfer assembly. The rear bogey has the on-board grain bin and steerable powered wheel assembly. U.S. Pat. No. 6,339,917 discloses a similar articulated combine where the forward bogey is devoid of an on-board grain bin, but carries the operator's cab, engine, grain harvesting assembly, and grain transfer assembly. The rear bogey has the on-board grain bin and a powered wheel assembly. Tracks, one wheel pair, and two wheel pairs, are illustrated for the harvester.

Finally, application Ser. No. 12/002,714, filed Dec. 18, 2007, discloses an improved harvester, which includes the rearward bogey having a powered wheel assembly of a powered stiff axle wheel assembly pivotable for steering the articulated harvester when the joint has articulated by a defined number of degrees. The joint may be connected to the rearward bogey powered stiff axle wheel assembly by a beam that has a second joint disposed ahead of the stiff axle and actuatable to crab the articulated harvester for grain unloading. The disclosures of these patents and application are expressly incorporated herein by reference.

While modification of one of the foregoing articulated combines, especially as disclosed in U.S. Pat. No. 6,012,272, has obvious utility for the integral harvester-borne baler disclosed herein, virtually any baler could be modified to produce the unique trapezoidally-shaped crop residue bale configuration disclosed herein.

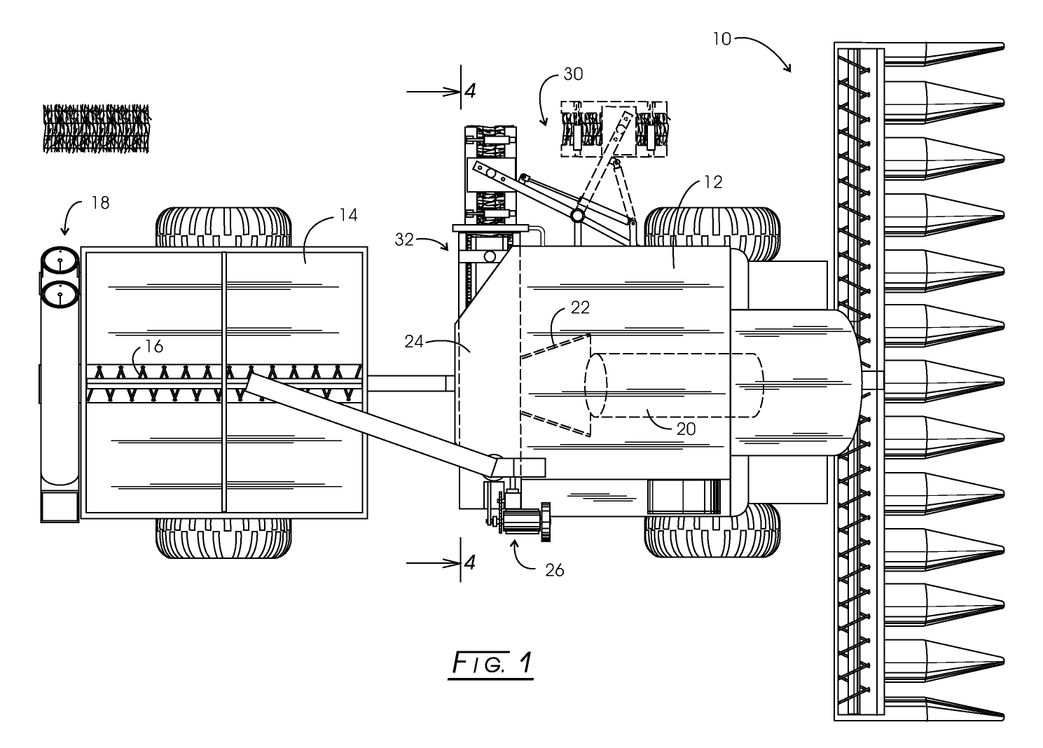

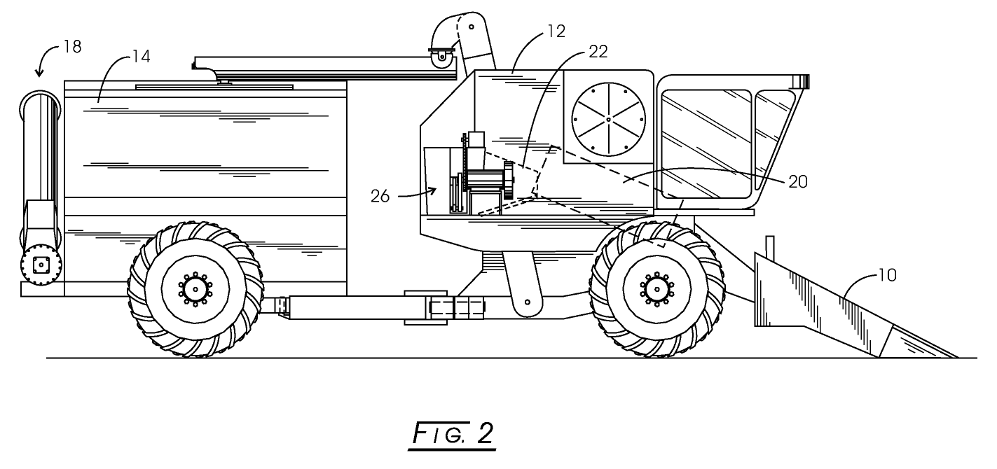

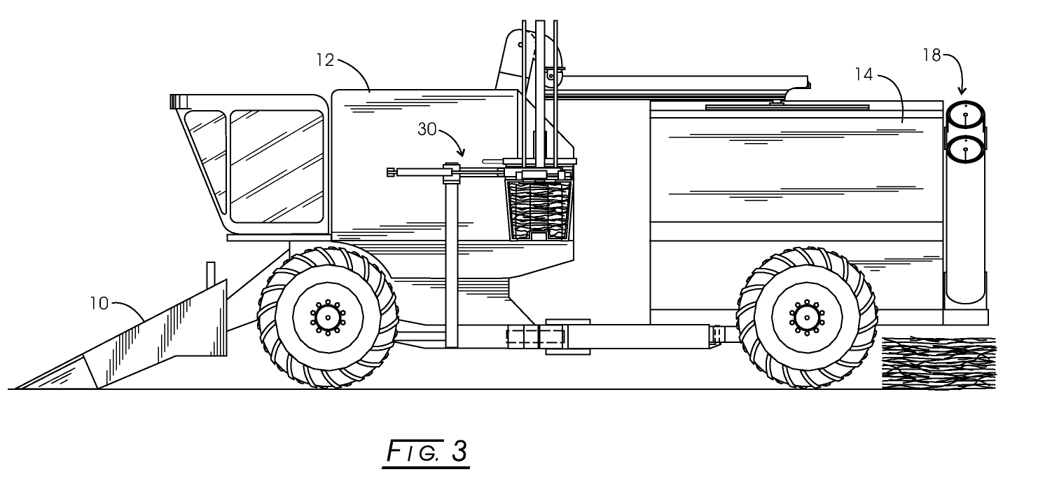

The general design, layout, and operation of an articulated combine can be found in the immediately cited patents. Only a cursory description, then, will be set forth below in order to understand the crop residue baler disclosed herein. Referring initially to FIGS. 1-3, a 12-row, 30-foot cornhead, 10, is shown being carried by a forward bogey, 12. Also shown, is a rearward grain bogey, 14, which has 4 inwardly sloping sides for gravity feeding of grain to a lower grain transfer auger, 16, which feeds a grain unloading assembly, 18, located at the rear of rearward bogey 14.

The disclosed integral crop residue baler is located in the rear section of forward bogey 12, where the engine and drive system normally would be, transverse to the travel direction of the harvester. In particular, a rotor, 20, is disposed at the forward area of this location and connects to a chute, 22, which feeds a baler, 24. The drive and flywheel assembly, 26, is located on one side of bogey 12, while the knotter assembly, 28, is disposed on the side opposite. A discharge bale assembly for the baled crop residue, 30, is located below a knotter assembly, 32. The residue/bale apparatus could be located in either transverse direction.

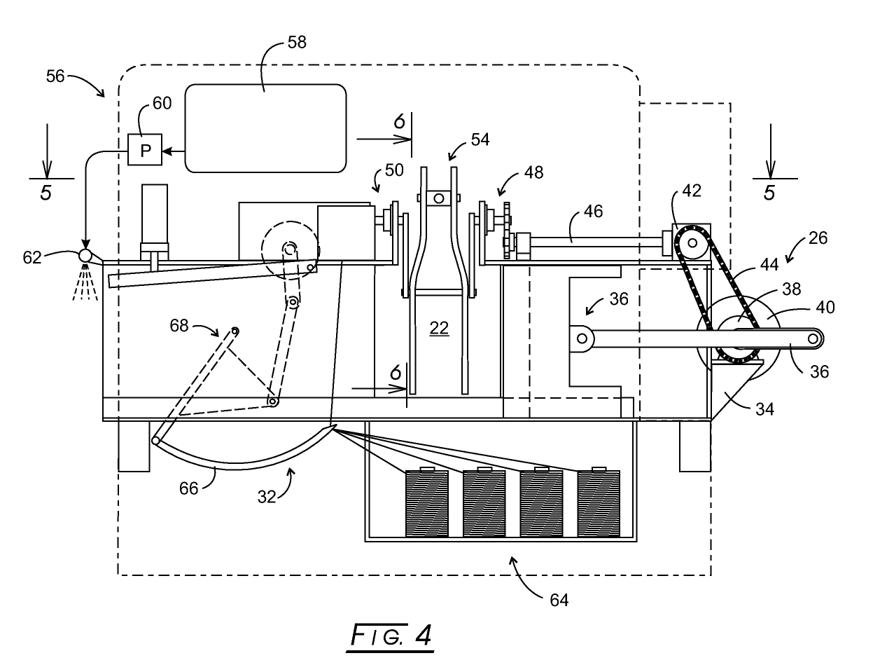

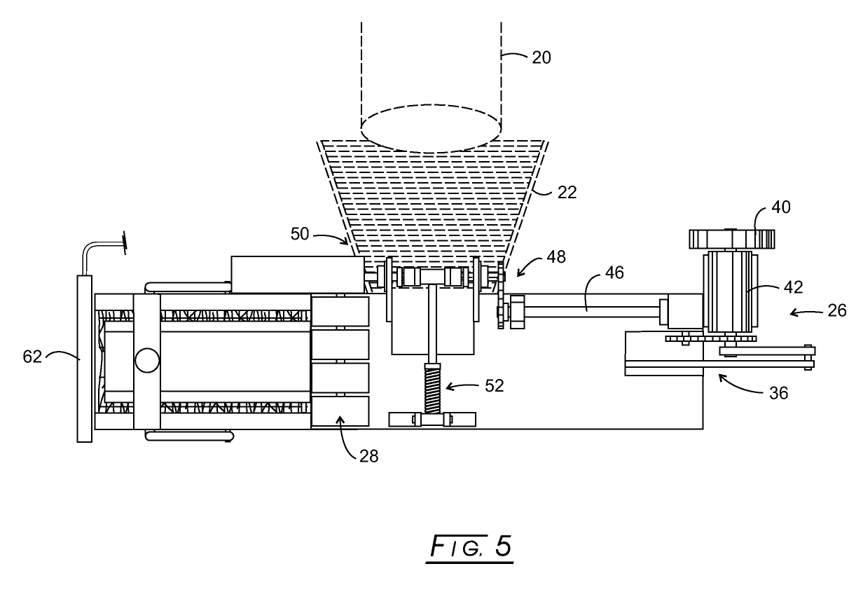

Referring to FIGS. 4-6, drive and flywheel or feeder assembly 26 sits atop bogey 12. A bracket, 34, supports a plunger assembly, 36, a hydraulic motor, 38, and a flywheel, 40. Hydraulic motor 38 is connected to a bevel gearbox, 42, by a drive chain, 44. Gearbox 42 is connected to a drive shaft, 46, that is connected to a gear drive assemblies, 48 and 50, for powering a feeder/packer assembly, 52 (see FIG. 5 also), and feeder assembly, 54 (see FIG. 6 also).

Also illustrated in FIG. 4 is a waterproof coating dispenser assembly, 56, that includes a reservoir, 58, a pump, 60, and a spray assembly, 62, for spraying waterproof material only the top of a bale formed by the baler disclosed herein.

Knotter assembly 32 also is powered via shaft 46. Spools of twine or other material, 64, feed material to needles typified by a needle, 66, connected to a lever assembly, 68, for binding the bales in conventional fashion. Knotter assembly operates in harmony with plunger assembly 36 that pushes and compacts crop residue in a bale chamber and with coating dispenser assembly 56.

Referring now to FIG. 6, feeder assembly 54 is conventional in construction, such as provided by New Holland or other baler manufacturer. Accordingly, such conventional feeder includes a bale chamber, 70, slotted pan, 72, and feeder fork assembly, 58, whose shaft is located on top of bale chamber 54. A feeder fork assembly, 74, is disposed atop bale chamber 70 in conventional fashion. Also in conventional fashion, bale chamber 70 has slots in its top to accommodate the forks of feeder fork assembly 74.

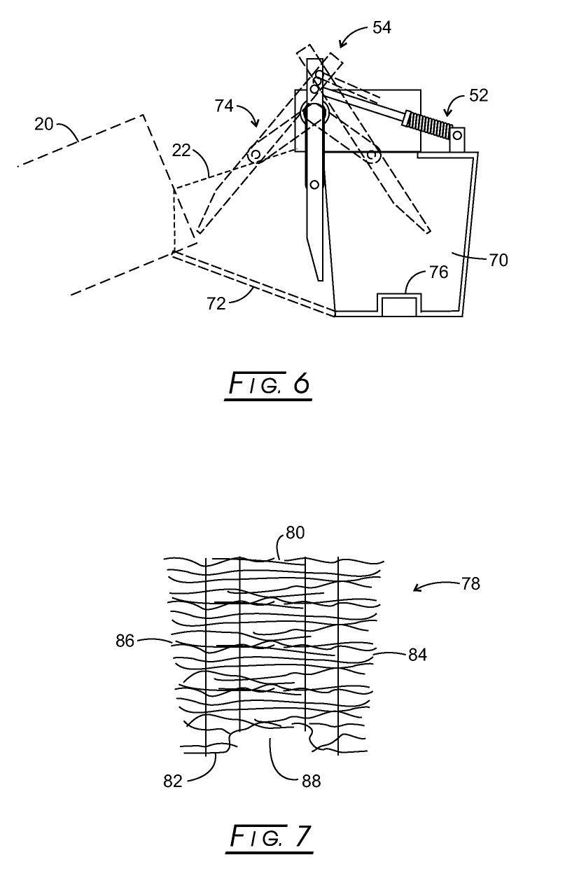

Bale chamber 70 is trapezoidal in outer configuration, with a raised lower central channel, 76. This configuration produces a bale, 78, as illustrated in FIG. 7. In particular, bale 78 has a top, 80, that is longer in dimension than its bottom, 82. Sidewalls, 84 and 86, slope inwardly from top surface 80 to bottom surface 82 to complete the trapezoidal configuration transferred from chamber 70 to bale 78. Channel 76 in chamber 70 produces an empty or hollow channel, 88, in bottom surface 82 of bale 78. Channel 88 may or may not be centered in bottom surface 82. The unique bale chamber could be used on any non-round baler. It makes a bale, which is more weather resistant. When the bale is lying on the ground, it tends to shed water because the top is wider and the bottom tunnel provides an air path to keep the bottom drier and, therefore, reduce rotting. When coupled with the water resistant top coating, this shape generates a bale that should retain its quality much longer than a conventional shaped uncoated bale when exposed to weather.

In operation, the baling process has been inserted in a transverse direction just behind the separation means of the harvester, which typically is a rotor and concave arrangement that places the grain and the smaller residue onto the cleaning means of the machine. The larger pieces of residue typically are discharged at the rear of the rotor cage. In some cases, the material is accelerated or chopped and accelerated by a rotary means. In some cases, it is directly discharged into a residue spreading means.

The disclosed integrated baler system will accept the residue as it exits the rotor, feed it into a forming chamber, compress it into the desired density and shape, and restrain it from expanding after it leaves the compression or forming chamber. The top of the bale will be coated with a weather resistant material as it exits the forming chamber and is placed on the ground outside the path of the rear axle of the machine. The baling system also could be configured to intercept the residue being discharged by the cleaning system of the harvester.

The operator can interrupt the baling function intermittently by disabling the forming and restraining means. Uncompressed residue would be pushed out the side of the machine and down to the ground. The machine can be converted to a non-baling mode in a short period of time by disabling all baling functions and changing the internal material flow vanes to allow the residue to flow to conventional spreading mechanism at the back of the harvesting module in the front of the grain-transporting module.

As disclosed above, the primary power input is at the material compressing assembly, typically a plunger mechanism, which is mounted on the side of the forward bogey. The reciprocating motion of the plunger is provided by a gearbox, eccentric, and flywheel to smooth energy flow to the reciprocating load of the plunger. The output of this primary gearbox is further directed to the fork type feeder mechanism that must be timed with the plunger. The same power is further directed to a bale shape retention assembly, typically a needle and twine tying arrangement. The spiked wheel that measures bale length triggers the needles and knotter to cycle. The feeder, which takes the rotor discharge of residue and pushes it into the path of the plunger is mounted on top of the bogey body with its forks extending down into the residue flow path. Its reciprocating motion clears the plunger on its forward motion to compress the material and force it into the forming section. Flow of material through the forming section is resisted by pressure from the outer walls of the chamber being held inward.

Bale 78 can be discharged via a hydraulic bale handler 30. In particular, hydraulic bale handler 30 grabs/squeezes each formed bale after the waterproof coating has been sprayed on the top surface of the bale and rotates 90° perpendicular to the side of forward bogey 12 and places the bale on the ground in the orientation depicted in FIG. 7. Such hydraulic bale handler is conventional in construction and operation.

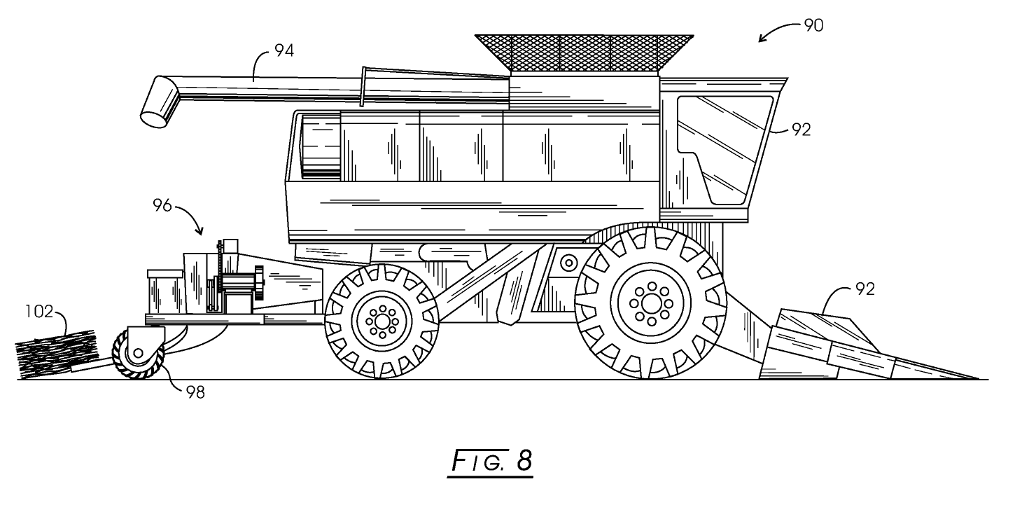

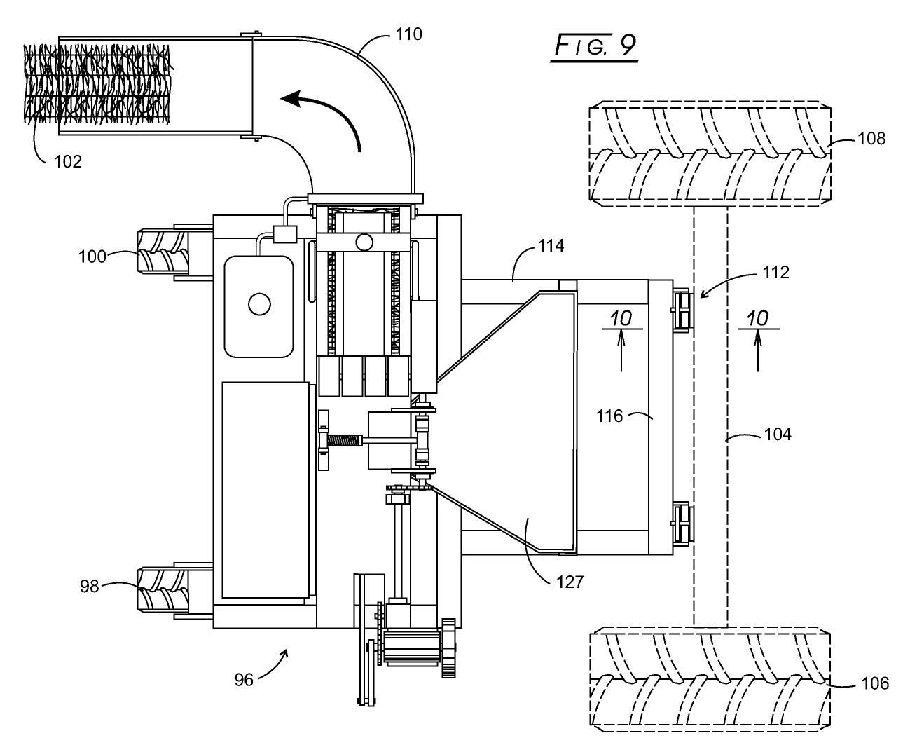

In FIG. 8, an alternative embodiment of the disclosed transverse crop residue bale is illustrated for a combine, 90, is shown as a conventional harvester/combine having a forward cornhead, 92, operator cab, 92, a grain harvesting assembly (not specifically shown), a grain transfer assembly, 94, and on-board grain bin (not specifically shown). Located behind and towed by combine 90 is a transverse crop residue baler, 96, riding on caster wheels, 98 and 100 (see FIG. 9), and discharging a crop residue baler, 102. From FIG. 9, it will be observed that transverse crop residue baler 96 is attached to combine 90 at two widely spaced apart locations by joints to be described later. Conveniently, the joints are attached to the combine rear axle, 104, disposed between combine rear wheels, 106 and 108. Each joint is spaced inwardly from the combine rear wheels sufficiently so that the powered rear combine wheels can turn about 45°. Such widely spaced-apart joints means that towed transverse crop residue baler 96 will follow combine 90 as if they were a single, integral unit. As will be described below, towed transverse crop residue baler 96 is only permitted to move in the pitch (Z) axis by the joints.

Towed transverse crop residue baler 96 operates just like crop residue baler 24 described above, but for the discharge mechanism which can be located on either side of the combine. Accordingly, a detailed description of towed transverse crop residue baler 96 will be omitted; other than to observe that a crop residue receiving chute, 127, receives crop residue from the harvester towed crop residual baler 96 and fees such harvester crop residue to towed transverse crop residue baler 96. Since there is no trailer or other towed apparatus behind towed transverse crop residue baler 96, discharge bale assembly 30 can be replaced with a chute, 110, that follows spray assembly 62. Bale 102, then, will be gently placed on the ground in the desired orientation, such as illustrated in FIG. 8. Of course, baler 96 could employ discharge bale assembly 30 or any other assembly that transferred bale 102 from baler 96 to the ground.

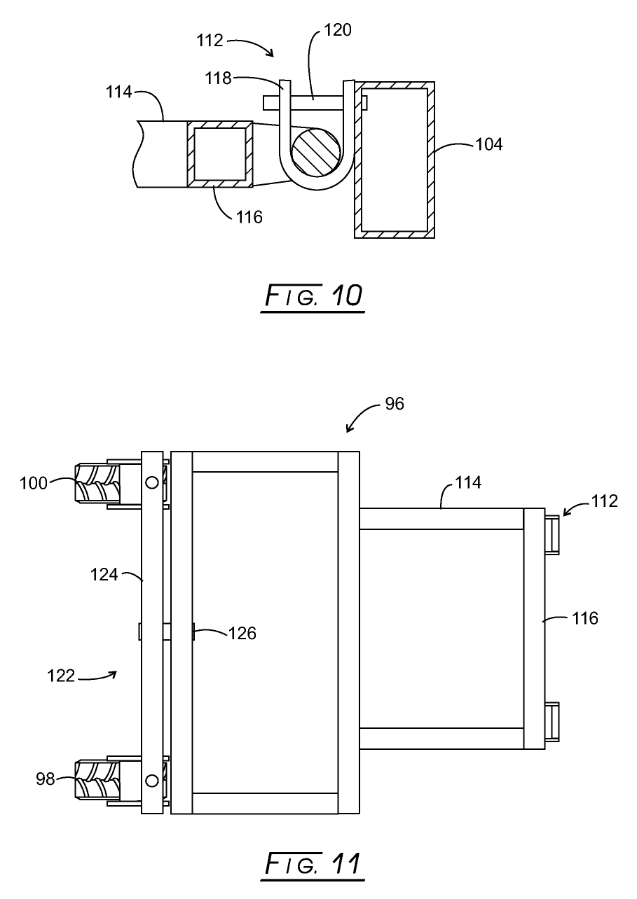

Referring now to FIG. 10, an attachment or joint assembly, 112, includes a tow bar assembly, 114 and “U” shaped receiver, 118, mounted on axle 104 and configured to receive a round transverse bar, 113. Of course, the other joint assembly, 116, is the same as joint assembly 112, so its description is omitted. Once round transverse tow bar 113 has been placed within receiver 118, a locking pin, 120, is inserted across the top of receiver 118 to secure baler 96 in its towed position. Such design of joint assembly 112, permits tow bar 114 and, hence, baler 96, to move only in the pitch axis (up and down); otherwise, baler 96 will behave as if it is part of or integral with combine 90.

The rear of baler 96 is supported by dual caster wheels movable 360° in the field or use mode, but restrained in the transport mode. As shown in FIG. 11, a rear wheel caster assembly, 122, that includes caster wheels 98 and 100 connected to a transverse connector bar, 124, which in turn is connected to a pivot arm, 126, pivotally connected to the rear of transverse crop baler assembly 96. Alternatively, caster wheels 98 and 100 could be replaced by a single centrally disposed caster wheel taking the place of pivot arm 126. For either configuration of caster wheels, this three-point load-carrying configuration allows the combination or integral combine/baler assembly able to negotiate rough terrain and move rearward as well without overt action from the combine operator to prevent jackknifing of the two vehicle assemblies.

In operation, the external residue chopper, on combines so equipped, is removed or configured to pass through crop residue without any chopping or spreading action being exerted on the crop residue. The intact crop residue, instead, is funneled directly into the compression stage of the baler by a conventional fork-type packer, as described above.

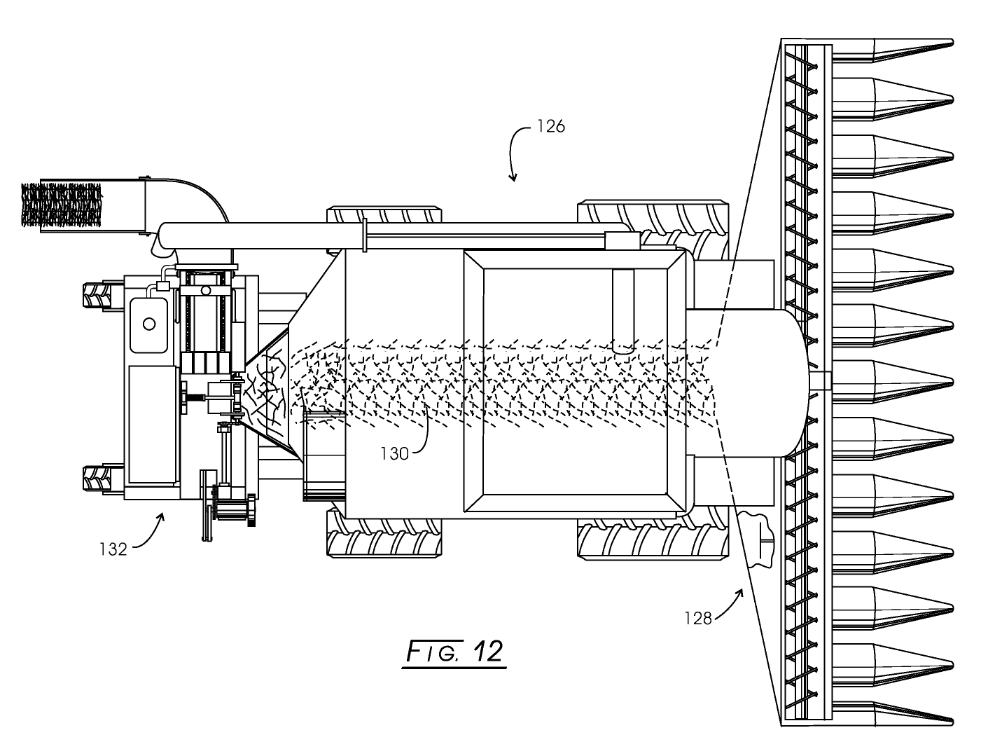

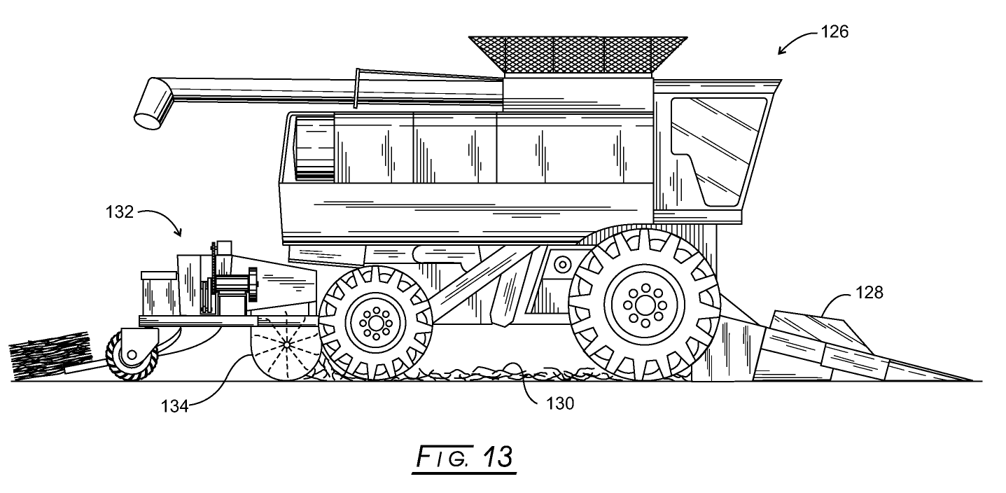

An alternative harvester/towed crop residue baler assembly is illustrated in FIGS. 12 and 13. In particular, an alternative harvester, 126, is fitted with a forwardly disposed cutter/windrower, 128, that creates a windrow of crop and/or crop residue, 130. A towed crop baler, 132, is fitted with a lower conventional baler material pickup, 134, that feeds crop windrow 130 lying on the ground into the rotating fork feeder/packer of pickup 134 into crop baler 132 for baling in the manner described above for both the towed and harvester carried crop residue balers. The windrow can be fed alone or along with additional crop discharged by harvester 126.

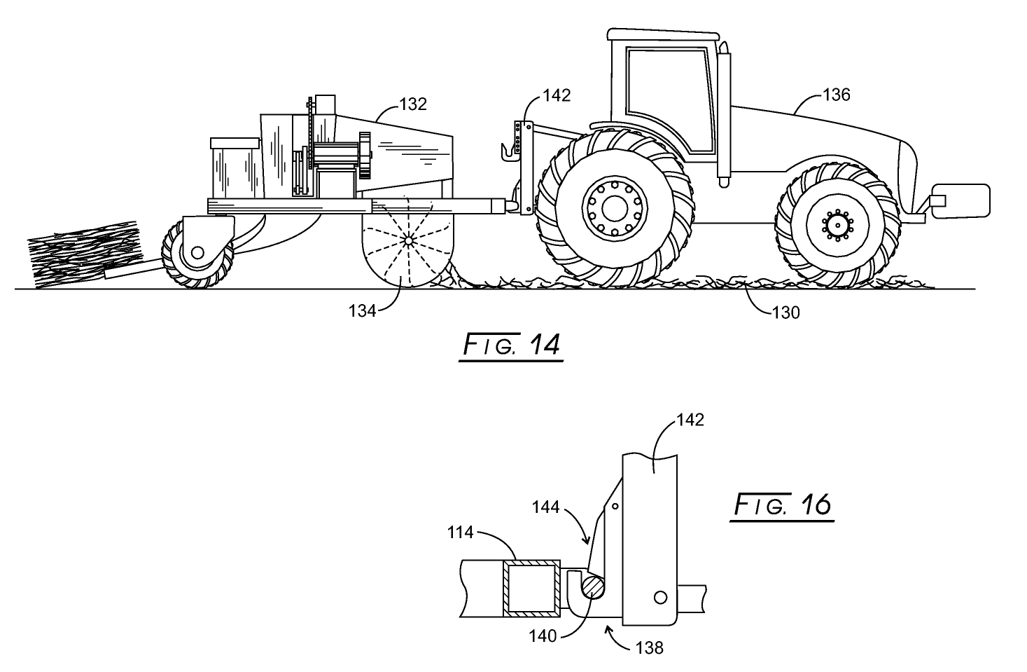

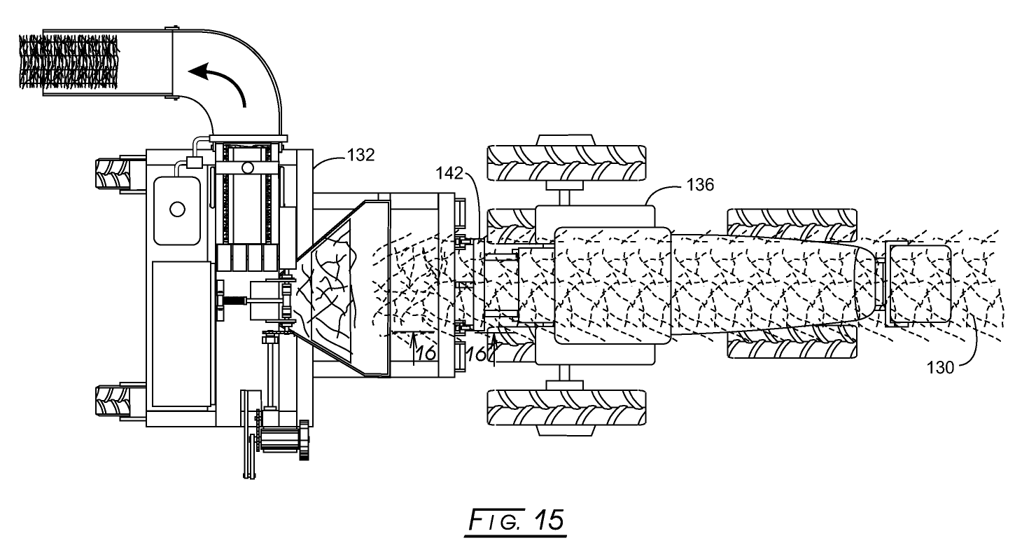

Yet another embodiment of the towed baler is illustrated in FIGS. 14-16. In this embodiment, however, a conventional farm tractor, 136, tows baler 132 that is fitted with lower conventional baler material pickup 134 that feeds crop windrow 130 lying on the ground into the rotating fork feeder/packer of pickup 134 into crop baler 132 for baling in the manner described above for both the towed and harvester carried crop residue balers. Crop window 130 is formed from crop, crop residue, or a mixture of crop and crop residue. For present purposes, “crop material” is used to refer to crop, crop residue, or a mixture of crop and crop residue.

Tractor 136 can be fitted with a conventional standard category 3 or 4 tractor quick hitch, with spacing of the two lower joints regulated by the hitch category. The upper, 3rd point of the hitch remains unused. The same frame and joint assembly shown in FIGS. 10 and 11 can be used in this embodiment, except that the joint assemblies need to protrude less from the frame that in the combine embodiment. A logical question is why cannot the tow bar and joint assemblies be the same for a combine as for a tractor. In theory, they could be; however, the turning moment on the combine rear axle is reduced if the joint spacing (joints 112 and 116) is as far apart as possible. The spacing for a category 3 or 4 tractor quick hitch is determined by the ASAE standard for tractor three point quick hitches.

Referring now to FIG. 16, a joint assembly, 138, for the tractor embodiment is shown to be a simple round transverse bar, 140, carried by tow bar 114. Round transverse bar 140 in turn fits into a tractor hitch, 142, which includes a U-receiver with spring lock assembly, 144. The other joint assembly is the same as joint assembly 138 and will not be described in detail. The tow bar and joint design, however, is such that the tractor (or combine in the towed embodiment) carries a portion of weight of said towed rear baler.

While the apparatus and its operation has been described with reference to various embodiments, those skilled in the art will understand that various changes may be made and equivalents may be substituted for elements thereof without departing from the scope and essence of the disclosure. Additionally, many modifications may be made to adapt a particular situation or material to the teachings of the disclosure without departing from the essential scope thereof. Therefore, it is intended that the disclosure may not be limited to the particular embodiments disclosed, but that the disclosure will include all embodiments falling within the scope of the appended claims. In this application the US measurement system (foot, gallon, and pound) is used, unless otherwise expressly indicated. Also, all citations referred to herein are expressly incorporated herein by reference.

I claim:

1. A combine having an integral crop residue baler, which comprises:
(a) an operator's cab, an engine, a grain harvesting assembly, a grain transfer assembly, a grain bin for receiving grain from said grain transfer assembly, and a grain off-loading assembly; and
(b) a transverse crop residue baler disposed at the rear of said combine and moving integrally therewith for forming a crop residue bale.

2. The combine of claim 1, which is devoid of an on-board grain bin and is a forward unit; said transverse crop residue baler is disposed at the rear of and is carried by said forward unit; and said combine further comprises:
(c) a rearward unit jointedly attached to said combine and having, steerable and powered wheel assembly, an on-board grain bin for receiving grain from said forward section grain transfer assembly, and a grain off-loading assembly.

3. The combine of claim 1, wherein the transverse crop residue baler produces a tied, trapezoidally-configurated crop residue bale comprising:
(a) a top surface having a top width;
(b) a bottom surface having a bottom width that is less than said top width;
(c) a pair of side surfaces sloping inwardly from said top surface to said bottom surface;
(d) a front surface;
(e) a back surface; and
(f) a channel interrupting said bottom surface and running from said front surface to said back surface.

4. The combine of claim 1, wherein said crop residue bale has a top and wherein said combine is additionally fitted with a spray assembly for spraying a layer of waterproof material onto the top of said crop residue bale.

5. The combine of claim 1, which is fitted with a knotter assembly for tying said crop residue bale.

6. The combine of claim 1, wherein the combine is fitted with a cutter/windrower for creating a crop material windrow; said crop residue baler has a baling chamber and is equipped with a chute to accept said crop material in said windrow, wherein said chute urges said crop material into said baling chamber.

10. A tied, trapezoidally-configuration crop residue bale comprising:
(a) a top surface having a top width;
(b) a bottom surface having a bottom width that is less than said top width;
(c) a pair of side surfaces sloping inwardly from said top surface to said bottom surface;
(d) a front surface;
(e) a back surface; and
(f) a channel interrupting said bottom surface and running from said front surface to said back surface.

11. The tied, trapezoidally-configuration crop residue bale of claim 10, wherein said top surface is coated with a layer of waterproof material.

12. A method for forming a crop residue bale from crop residue, which comprises the steps of:
(a) providing a combine having an integral crop residue baler, wherein said combine comprises an operator's cab, an engine, a grain harvesting assembly, a grain transfer assembly, and a grain bin for receiving grain from said grain transfer assembly; and said integral crop residue baler is disposed at the rear of said combine and moves integrally with said combine;
(b) moving said combine and integral baler across a field of grain for said combine to harvest said grain and produce a crop residue;
(c) moving said harvester produced crop residue into said integral crop residue baler for forming a crop residue bale having a top surface.

13. The method of claim 12, wherein said combine is devoid of an on-board grain bin and is a forward unit; said transverse crop residue baler is disposed at the rear of and is carried by said forward unit; and said combine further comprises:
(c) a rearward unit jointedly attached to said combine and having, steerable and powered wheel assembly, an on-board grain bin for receiving grain from said forward section grain transfer assembly, and a grain off-loading assembly.

14. The method of claim 12, wherein the transverse crop residue baler produces a tied, trapezoidally-configurated crop residue bale comprising:
(i) a top surface having a top width;
(ii) a bottom surface having a bottom width that is less than said top width;
(iii) a pair of side surfaces sloping inwardly from said top surface to said bottom surface;
(iv) a front surface;
(v) a back surface; and
(vi) a channel interrupting said bottom surface and running from said front surface to said back surface.

15. The method of claim 12, wherein said combine is additionally fitted with a spray assembly for spraying a layer of waterproof material onto the top of said crop residue bale.

16. The method of claim 12, wherein the combine is fitted with a cutter/windrower for creating a crop material windrow; said crop residue baler has a baling chamber and is equipped with a chute to accept said crop material in said windrow, wherein said chute urges said crop material into said baling chamber.

17. The method of claim 16, where said crop residue baler accepts crop residue both from said combine and from said windrow.

18. The method of claim 12, wherein said combine tows said transverse crop residue baler which baler is connected to said combine by two widely spaced-apart joints that permit only movement in the pitch axis.

19. The method of claim 18, wherein said towed transverse crop residue baler is supported by a single rotable caster wheel.

20. The method of claim 18, wherein said towed transverse crop residue baler is supported by a caster wheel assembly comprising a pair of spaced-apart caster wheels pivotally connected to said baler.

21. A tractor assembly for baling crop material, which comprises:
(a) a tractor fitted with a quick hitch assembly for towing; and
(b) a towed transverse crop baler fitted with a baler material pickup and towed by said tractor, said baler connected to said tractor by said quick hitch assembly configured such that only movement in the pitch axis is permitted and such that tractor carries a portion of weight of said towed rear unit.

22. The tractor assembly of claim 21, wherein said crop baler has a baling chamber and is equipped with a rotating fork feeder/packer, wherein said rotating fork feeder/packer urges said crop material into said baling chamber.

23. The tractor assembly of claim 21, wherein said towed transverse crop baler is supported by a single rotable caster wheel.

24. The combine of claim 23, wherein said towed transverse crop baler is supported by a caster wheel assembly comprising a pair of spaced-apart caster wheels pivotally connected to said baler.
